(19) United States
(12) Patent Application Publication
(10) Pub. No.: US 2005/0227703 A1
(43) Pub. Date: Oct. 13, 2005

(54) METHOD FOR USING BASE STATION POWER MEASUREMENTS TO DETECT POSITION OF MOBILE STATIONS

(76) Inventor: Steven D. Cheng, San Diego, CA (US)

Correspondence Address: NORTH AMERICA INTELLECTUAL PROPERTY CORPORATION, P.O. BOX 506, MERRIFIELD, VA, 22116, US

(21) Appl. No.: 10/708,872

(22) Filed: Mar. 30, 2004

(51) Int. Cl. H04B 1/38

(52) U.S. Cl. 455/456.1; 455/456.5

(57) ABSTRACT

A method of using power measurements from base stations to calculate position of a mobile station. The method includes providing position coordinates for a plurality of base stations in a mobile phone network, measuring Received Signal Strength Indicator (RSSI) levels of nearby base stations with a mobile station, identifying three base stations for which the mobile station measures strongest RSSI levels, the mobile station receiving the position coordinates of the three identified base stations, calculating a curved path of possible positions of the mobile station for each of the three identified base stations according to the measured RSSI levels of each of the three identified base stations, and calculating the position of the mobile station based on the position coordinates of the three identified base stations and the three curved paths of possible positions of the mobile station.

### BACKGROUND OF INVENTION

1. Field of the Invention

The present invention relates to detecting a location of a mobile station, and more specifically, to a method for using embedded functionality in mobile stations to measure base station power levels for determining a location of the mobile station.

2. Description of the Prior Art

The Global Positioning System (GPS) is a popular approach used for location detection. The North American wireless market has mandated that after the year 2003, mobile stations (handsets) will need to provide a GPS receiver in order to support Emergency 911 (E911) services. Currently, there are several GPS approaches. Among these, the typical GPS without Selective Availability (SA) approach (accuracy of the original GPS system is subject to accuracy degradation under the government imposed Selective Availability program) is chosen by the above E911 services.

Unfortunately, the GPS based approach is not a perfect way for mobile stations at any time any place. For example, a GPS receiver cannot receive good signals inside buildings and cannot receive good signals under severe weather conditions. The location service applications implemented using GPS receivers rely on signals broadcast from multiple satellites. Like other wireless communication technologies, GPS receivers suffer from interference effects. They also suffer from line-of-sight problems. The users of GPS receivers may be aware of some of these kinds of problems. For example, the users may already know that a GPS receiver cannot receive good quality signals inside buildings. Meanwhile, when the GPS receiver cannot receive good quality signals, it will not provide accurate location services. This is crucial to users who need to use mobile stations to reach for help. If the mobile station cannot derive its location through the GPS receiver properly, the mobile station will have problems reporting its location to the related system. Thus, the GPS approach adopted by the North American wireless market is a problem prone approach for location services such as E911.

### SUMMARY OF INVENTION

It is therefore an objective of the claimed invention to introduce a method for using existing features embedded inside mobile stations for complementing or further improving the current GPS approach in order to solve the above-mentioned problems.

According to the claimed invention, a method of using power measurements from base stations to calculate position of a mobile station is proposed. The method includes providing position coordinates for a plurality of base stations in a mobile phone network, measuring Received Signal Strength Indicator (RSSI) levels of nearby base stations with a mobile station, identifying three base stations for which the mobile station measures strongest RSSI levels, the mobile station receiving the position coordinates of the three identified base stations, calculating a curved path of possible positions of the mobile station for each of the three identified base stations according to the measured RSSI levels of each of the three identified base stations, and calculating the position of the mobile station based on the position coordinates of the three identified base stations and the three curved paths of possible positions of the mobile station.

It is an advantage of the claimed invention that RSSI level measurements are used to determine an equivalent GPS location of the mobile station. Thus, even when mobile stations cannot receive good quality GPS information from the satellites, the mobile stations will still be able to perform the same type of location services. More importantly, the claimed invention method does not require any extra hardware for the mobile stations, and the neighboring cell RSSI measurement is part of the cell selection and reselection routines already used in Global System for Mobile communications (GSM) protocols and can be extended to the Code Division Multiple Access (CDMA) protocols.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a diagram illustrating how to derive longitude and latitude information of a mobile station using the longitude and latitude information of adjacent base stations.

FIG. 2 is a diagram illustrating how to derive longitude and latitude information of the mobile station while in a moving state.

FIG. 3 is a diagram illustrating a RSSI signal distribution layout for each base station.

FIG. 4 is a diagram illustrating a RSSI signal distribution layout with interference effects.

FIG. 5 is a diagram illustrating distances of a curved path, a first outer curve, and a first inner curve from a first base station.

FIG. 6 illustrates an area formed by the union of inner and outer curves for each of three base stations.

FIG. 7 is a diagram illustrating received RSSI sampling statistics on Verizon base station channel 426.

FIG. 8 is a diagram illustrating received RSSI sampling statistics on Spirit base station channel 25.

FIG. 9 is a diagram illustrating using static longitude and latitude information of a base station to adjust received GPS longitude and latitude information of the mobile station.

### DETAILED DESCRIPTION

The goal of the present invention method is to measure the RSSI levels of base stations in neighboring cells to calculate the location of a mobile station. If the GPS location information of each base station can be known beforehand, then the location information derived from the base station RSSI measurement process can be translated to GPS information directly.

In the CDMA protocol, the GPS location information of each base station is broadcast through system information messages. Currently, in the GSM 2G and 2.5G (GPRS) protocols, GPS information is not provided, but it is included in the GSM 3G Wideband CDMA (W-CDMA) protocols. It is a small enhancement for GSM-GPRS protocols to include the GPS information to be associated with each base station, and including the GPS information will help to provide a better location service through the GSM communication protocol. The mapping between the base station's GPS location and its base station identification is a one-to-one mapping. Thus, even if there is no base station GPS information available through the system information broadcasting, it is possible to translate between the base station identification code and its GPS information through an offline table search or even an online automatic search.

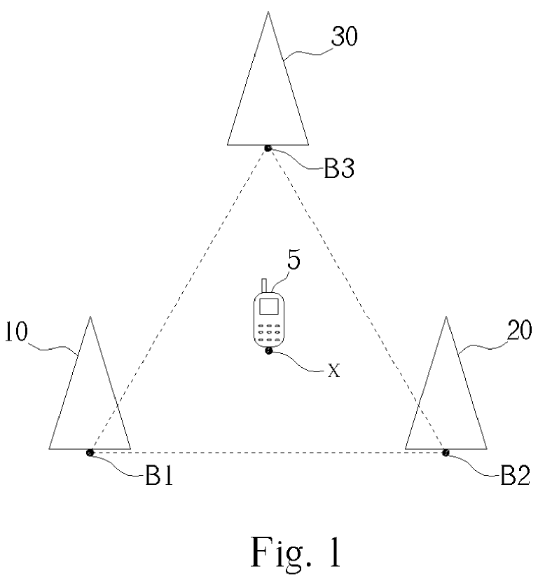

Please refer to FIG. 1. FIG. 1 is a diagram illustrating how to derive longitude and latitude information of a mobile station 5 using the longitude and latitude information of adjacent base stations. The mobile station 5 is shown located between a first base station 10, a second base station 20, and a third base station 30 of a mobile phone network. The mobile station 5 is located at position x having a longitude and latitude of (lox, lax). The first base station 10, the second base station 20, and the third base station 30 are respectively located at positions B1, B2, and B3. The positions B1, B2, and B3 have respective coordinates of (lo1, la1), (lo2, la2), and (lo3, la3).

When the mobile station 5 falls into the range among the three base stations 10, 20, 30 as shown in FIG. 1, the following GPS-constraints for the mobile station 5 can be derived:
Minimum{lo1, lo2, lo3}=<lox=<Maximum{lo1, lo2, lo3}
Minimum{la1, la2, la3}=<lax=<Maximum{la1, la2, la3}

Assume that the distance between any two adjacent Pico cells is usually 75 meters. What this indicates is that that the precision of using the approach shown above for deriving the longitude and latitude for a mobile station 5 is at most 75 meters.

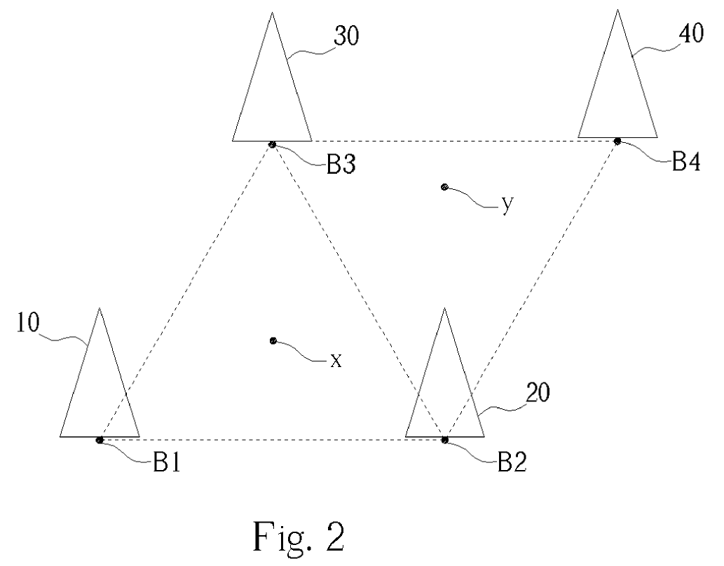

Please refer to FIG. 2. FIG. 2 is a diagram illustrating how to derive longitude and latitude information of the mobile station 5 while in a moving state. When the mobile station 5 moves from position x to position y as shown in FIG. 2, its GPS longitude and latitude will also be automatically updated due to the change among the serving cell and the neighbor cells. The new position of the mobile station 5 shown in FIG. 2 is between the second base station 20, the third base station 30, and a fourth base station 40.

Assume that the fourth base station 40 is located at position B4, having longitude and latitude of (lo4, la4), and that the longitude and latitude of the mobile station 5 at position y is (loy, lay). Constraints used in deriving the coordinates of position y can then be determined as follows:
Minimum{lo4, lo2, lo3}=<loy=<Maximum{lo4, lo2, lo3}
Minimum{la4, la2, la3}=<lay=<Maximum{la4, la2, la3}

Therefore, whenever the position of the mobile station 5 changes, the general location of the mobile station 5 can easily be determined using the position of nearby base stations, which provide strong signals with high RSSI levels to the mobile station 5.

Assume that in position x, the mobile station 5 receives a first RSSI value from the first base station 10, a second RSSI value from the second base station 20, and a third RSSI value from the third base station 30. Also, assume for now that there are no interference effects. For each base station, the strength of the RSSI values the mobile station 5 receives from the base station is inversely proportional to the square of the distance between the mobile station 5 and the base station. Therefore, curved paths indicating the possible position of the mobile station 5 can be calculated.

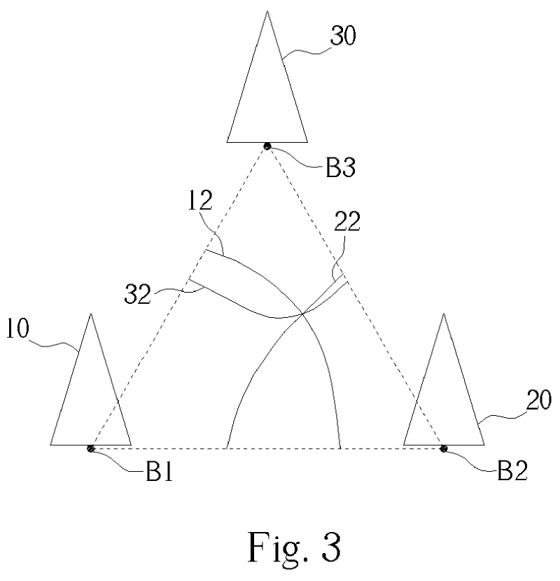

Please refer to FIG. 3. FIG. 3 is a diagram illustrating the RSSI signal distribution layout for each base station. Based on the strength of the RSSI values received from the first base station 10, a first curved path 12 is calculated. The first curved path 12 indicates that the mobile station 5 is located at some point along the first curved path 12. By considering the strength of the RSSI values received from the second base station 20 and the third base station 30, a second curved path 22 and a third curved path 32 can be calculated, respectively. Techniques used to triangulate the position of an object are well known, and will not be discussed in great detail here. As can be seen in FIG. 3, the intersection of the first, second, and third curved paths 12, 22, and 32 can clearly indicate the precise location of the mobile station 5.

That is, an algorithm φ can be developed to calculate the position of the mobile station 5. The inputs for the algorithm φ are the longitude, latitude, and RSSI measurements for each of the three base stations 10, 20, and 30, and the outputs for the algorithm φ are the longitude and the latitude of the mobile station 5. The inputs and the
({longitude(v1), latitude(v1), RSSI(v1)},{longitude(v2), latitude(V2), RSSI(v2)},{longitude(v3), latitude(v3), RSSI(v3)})=[Longitude(x), latitude(x)]

wherein v1, v2, and v3 represent three different base stations and x represents the mobile station 5.

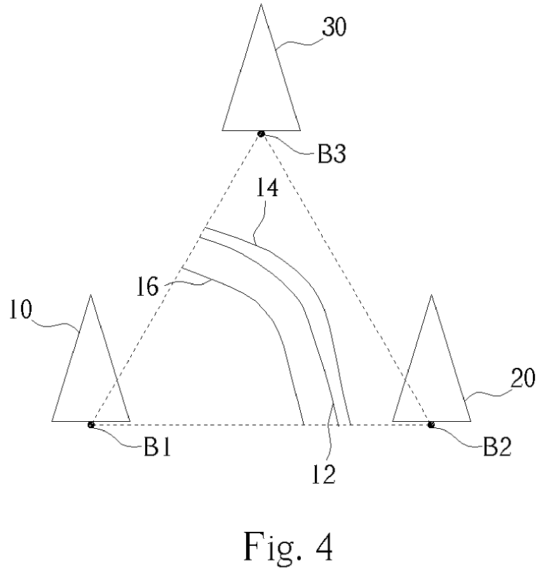

Unfortunately, interference effects reduce the certainty and the precision in which the location of the mobile station 5 can be pinpointed. Please refer to FIG. 4. FIG. 4 is a diagram illustrating the RSSI signal distribution layout with interference effects. The normal first curved path 12 corresponding to the first base station 10 is shown in FIG. 4. Because of the uncertainty in the accuracy of the RSSI values received, a first outer curve 14 and a first inner curve 16 are calculated based on interference coefficients associated with the first base station 10. The curved area between the first outer curve 14 and the first inner curve 16 represents an area in which the mobile station 5 is predicted to be. It is possible that the mobile station 5 will receive the same RSSI values at any point within this curved area. The distances between the curved path 12 and each of the first outer curve 14 and the first inner curve 16 can be calculated using interference coefficients such as an average interference and a standard deviation of the interference associated with the first base station 10.

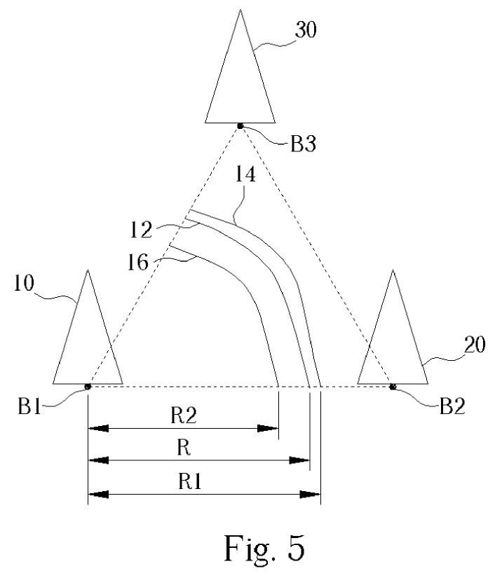

Please refer to FIG. 5. FIG. 5 is a diagram illustrating distances of the curved path 12, the first outer curve 14, and the first inner curve 16 from the first base station 10. Without considering interference, the mobile station 5 would be located on the curved path 12, which has a distance of R from the first base station 10. Considering the interference coefficients, a maximum distance that the mobile station 5 can be from the first base station 10 is calculated to be R1, and a minimum distance is R2.

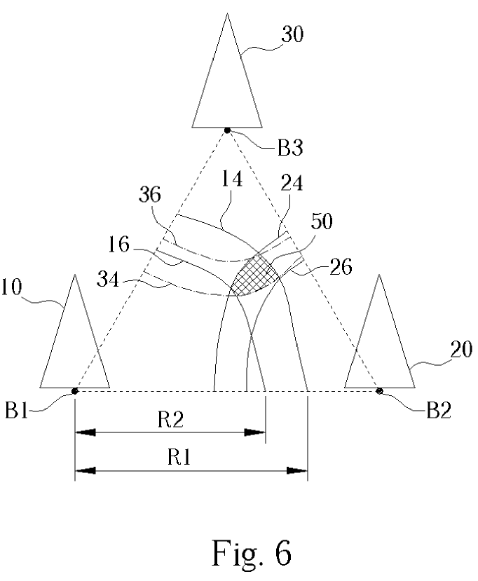

Please refer to FIG. 6. FIG. 6 illustrates an area 50 formed by the union of inner and outer curves for each of the three base stations 10, 20, and 30. When the RSSI level values for the first, second, and third base stations 10, 20, and 30 are measured considering interference effects, the area 50 is derived. That is, the RSSI(v1) parameter mentioned above now ranges from RSSI(v1)−δ(v1) to RSSI(v1)+δ(v1); RSSI(v1) now ranges from RSSI(v2)−δ(v2) to RSSI(v2)+δ(v2); and RSSI(v3) now ranges from RSSI(v3)−δ(v3) to RSSI(v3)+δ(v3).

If the maximum and minimum RSSI values from each base station are applied to the to the algorithm φ, eight different pairs of {[Longitude(x(i)), latitude(x(i))]| where i=1,2, . . . ,8} will be derived.

Let MaxLo be the maximum value of longitude among these eight different Longitude(x(i)).

Let MinLo be the minimum value of longitude among these eight different Longitude(x(i)).

Let MaxLa be the maximum value of longitude among these eight different Latitude(x(i)).

Let MinLa be the minimum value of longitude among these eight different Latitude(x(i)).

Based on the above minimum and maximum longitude and latitude values, we can now say that the mobile station 5 is located in an area bound by the following four coordinates:
{[MaxLo, MaxLa], [MaxLo, MinLa], [MinLo, MaxLa], [MinLo, MinLa]}

Besides the four coordinates shown above, the mobile station 5 can also calculate the area 50 by calculating the union of the inner and outer curves for each of the three base stations 10, 20, and 30. The area 50 contains all positions in which the curved areas corresponding to each of the three base stations 10, 20, and 30 overlap.

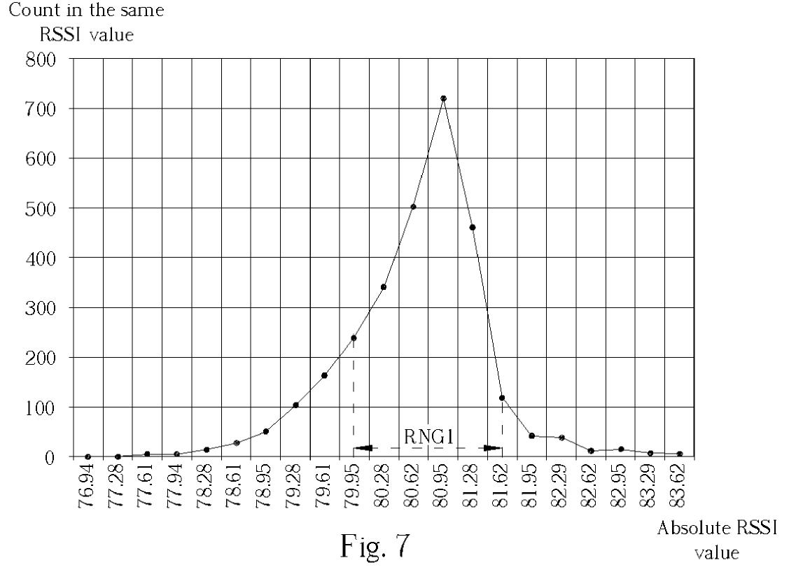

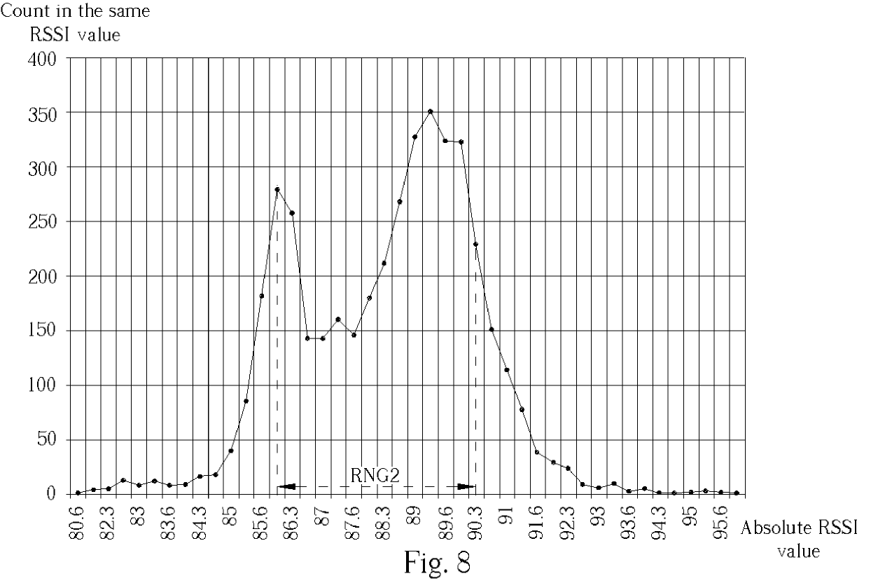

Please refer to FIG. 7 and FIG. 8. FIG. 7 is a diagram illustrating received RSSI sampling statistics on Verizon base station channel 426. FIG. 8 is a diagram illustrating received RSSI sampling statistics on Spirit base station channel 25.

Based on a Lab study by the inventor of the present invention, most RSSI values received from the same base stations follow some kind of distribution pattern as shown in FIG. 7 and 8. Also it seems that most of the RSSI samples fall into the range of mean minus standard deviation to mean plus standard deviation. Therefore, it is possible to derive a formula, φ, that can tolerate the general interference effects and suggest the possible distance answer based on the current RSSI input and the probability value, P, as follows:
φ(RSSI(v), P(v))=[maximum distance(r), minimum distance(r)]

For example, in the distribution pattern shown in FIG. 7, 75% of the RSSI sampling data falls into range RNG1. The range RNG1 contains RSSI values with absolute values between 79.95 and 81.62. We can then look for other locations with the mean of the received RSSI sampling data that is between 79.95 and 82.62, such that the first location falls between the base station (channel 426) and testing lab (with mean of RSSI sampling 79.95 ) and testing lab falls between the base station (channel 426) and the second location (with mean of RSSI sampling 82.62). The distribution pattern shown in FIG. 7 contains only one peak, and is more ideal than the pattern shown in FIG. 8 having two peaks. For the pattern shown in FIG. 8, 71% of the RSSI sampling data falls into range RNG2. The range RNG2 contains RSSI values with absolute values between 86.29 and 90.30.

In the GSM protocol cell selection and reselection process, the mobile station 5 keeps measuring the RSSI values from the multiple base stations at the same time. For the neighbor cell selection, the mobile station 5 will send the six strongest neighbor cell average RSSI values in a measurement report back to the serving cell in a periodic way. As discussed above, the RSSI values from three base stations can be used to predict the location of the mobile station 5. Since the mobile station 5 will experience different kinds of interference effects with some of the base stations RSSI measurements, it is possible to use the distribution result (such as those shown in FIG. 7 and FIG. 8) to judge which received base station RSSI data is more stable than other sets of received RSSI data. Among the base stations from the six strongest cells, the three base stations providing the most reliable RSSI data can be chosen for determining the location of the mobile station 5. A reliability coefficient can be assigned to each base station to aid in the selection of the three most reliable base stations. For example, base stations having reliability coefficients below a predetermined threshold level may be excluded from being used as one of the three most reliable base stations.

The longitude and latitude values of each base station are provided by the CDMA protocols, but not in the GSM and GPRS protocols. In order to derive the latitude and longitude values of each base station in a GSM-GPRS network, a table-mapping approach (such as a lookup table) can be used to implement the solution for this problem. Because each base station has a unique longitude and latitude and a unique base station identification code, a one-to-one mapping is used between the longitude and latitude coordinates and the base station identification code.

There are times when the position indicated by a commercially available GPS receiver deviates severely from the actual position of the GPS receiver. In a study performed by the inventor of the present invention, a commercially available Garmin® GPS receiver was compared with Location Position Radar (LPR) tools available from Qualcomm®. The study found that when there is a difference in longitude and latitude values derived from GPS satellites using the commercially available GPS receiver and the longitude and latitude values derived from the LPR tools, the difference in distance will often be greater than 100 meters. Since each base station has a fixed location, and since the longitude and latitude information for the base station can be precisely calculated, the position data from base stations can be given priority when there is an inconsistency in position found while using a GPS receiver and while calculating the position using RSSI values received from base stations.

Suppose that the mobile station 5 contains a built-in GPS receiver and also has the ability to utilize the present invention method for calculating its position using the strength of RSSI levels received from base stations. Some protocols such as CDMA or GSM W-CDMA will broadcast base station longitude and latitude information periodically. Using the present invention method of detecting position using average received RSSI data, the mobile station 5 can determine when it is less than a predetermined distance away from a base station. When the mobile station 5 detects that it is very close to a base station, the mobile station can then use the longitude and latitude information of the base station as the longitude and latitude of the base station. In this way, large deviations in calculated position from the actual position of the mobile station 5 can be avoided by using the precise location of the base station.

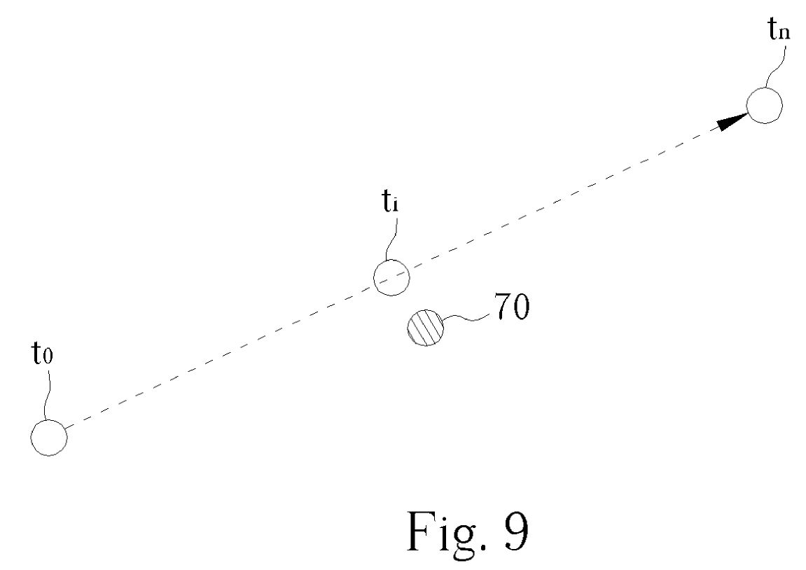

Please refer to FIG. 9. FIG. 9 is a diagram illustrating using static longitude and latitude information of a base station 70 to adjust received GPS longitude and latitude information of the mobile station 5.The mobile station 5 compares longitude and latitude data received from a GPS receiver built into the mobile station 5 with longitude and latitude calculated using average RSSI values to calculate a difference between the two positions. In FIG. 9, position of the mobile station 5 is shown at times t₀, tᵢ, and tₙ. At time t₀, the mobile station 5 detects that it is not within a predetermined distance of the base station 70 or any other base station. Later, at time tᵢ, the mobile station 5 uses average RSSI values to calculate that the mobile station 5 is within the predetermined distance from the base station 70. At this time, the mobile station 5 will replace the longitude and latitude information derived from the GPS receiver with the longitude and latitude information of the base station 70. The mobile station 5 then derives a delta δ(longitude) for the longitude and a delta δ(latitude) for latitude as reference parameters. After time tᵢ, the mobile station 5 will modify all the longitude and latitude information received from the GPS receiver (such as at time tₙ) using δ(longitude) and δ(latitude) until the mobile station 5 is at a location that is very close to a base station. Consequently, every time the mobile station 5 detects that it is very close to a base station, the mobile station 5 will use the longitude and latitude of the base station to derive the above reference parameters, and then use these reference parameters to adjust the received GPS longitude and latitude information.

In summary, the present invention method measures average RSSI level values to determine an equivalent GPS location of the mobile station. Thus, even when mobile stations cannot receive good quality GPS information from GPS satellites, the mobile stations will still be able to perform the same type of location services. More importantly, the present invention method does not require any extra hardware that needs to be added to the mobile stations, and the neighboring cell RSSI measurement is part of the cell selection and reselection routines already used in Global System for Mobile communications (GSM) protocols and can be extended to the Code Division Multiple Access (CDMA) protocols. Therefore, a mobile phone utilizing the present invention method can be used in applications such as location detecting for emergency services and E911 services where receiving correct location information of the mobile station is critical.

Those skilled in the art will readily appreciate that numerous modifications and alterations of the device may be made without departing from the scope of the present invention. Accordingly, the above disclosure should be construed as limited only by the metes and bounds of the appended claims.

1. A method of using power measurements from base stations to calculate position of a mobile station, the method comprising:
providing position coordinates for a plurality of base stations in a mobile phone network;
measuring Received Signal Strength Indicator (RSSI) levels of nearby base stations with a mobile station;
identifying three base stations for which the mobile station measures strongest RSSI levels;
the mobile station receiving the position coordinates of the three identified base stations;
calculating a curved path of possible positions of the mobile station for each of the three identified base stations according to the measured RSSI levels of each of the three identified base stations; and
calculating the position of the mobile station based on the position coordinates of the three identified base stations and the three curved paths of possible positions of the mobile station.

2. The method of claim 1 wherein calculating the curved path of possible positions of the mobile station for each of the three identified base stations is performed according to the relationship
$${RSSI}_{i} ∝ \frac{1}{{d}_{i}^{2}}$$
, wherein RSSIᵢ stands for a measured RSSI value for an i^{th} base station, and dᵢ stands for a distance between the mobile station and the i^{th} base station.

3. The method of claim 1 wherein when calculating the curved path of possible positions of the mobile station for each of the three identified base stations, a known interference coefficient for each base station is utilized to calculate an inner curve and an outer curve corresponding to that base station, the inner curve and the outer curve defining an individual area that the mobile station is predicted to be in.

4. The method of claim 3 wherein a merged area that the mobile station is predicted to be in is calculated based on a union of the individual areas from each of the three identified base stations, the merged area comprising positions in which all of the individual areas overlap.

5. The method of claim 3 wherein the known interference coefficients for each of the three identified base stations comprise a mean interference value and a corresponding standard deviation value that are used to calculate the inner curve and the outer curve corresponding to the same base station.

6. The method of claim 1 wherein each base station has a corresponding reliability coefficient due to interference effects associated with that base station, and when identifying the three base stations for which the mobile station measures the strongest RSSI levels, base stations which have a reliability coefficient below a predetermined threshold level are not selected to be one of the three base stations that the mobile station identifies as having the strongest RSSI levels.

7. The method of claim 1 wherein the mobile station receiving the position coordinates of the three identified base stations is realized by the three identified base stations transmitting their respective position coordinates to the mobile station.

8. The method of claim 1 wherein the mobile station receiving the position coordinates of the three identified base stations is realized by the mobile station reading the positions coordinates of the three identified base stations from a lookup table.

9. The method of claim 1 wherein when the mobile station is less than a predetermined distance away from a nearby base station in the mobile phone network, the position of the mobile station is set to be equal to the position of the nearby base station.

10. A method of using power measurements from base stations to calculate position of a mobile station, the method comprising:
providing position coordinates for a plurality of base stations in a mobile phone network;
measuring Received Signal Strength Indicator (RSSI) levels of nearby base stations with a mobile station;
identifying three base stations that have a reliability coefficient above a predetermined threshold level for which the mobile station measures strongest RSSI levels, wherein each base station has the corresponding reliability coefficient due to interference effects associated with that base station;
the mobile station receiving the position coordinates of the three identified base stations;
calculating a curved path of possible positions of the mobile station for each of the three identified base stations according to the measured RSSI levels of each of the three identified base stations; and
calculating the position of the mobile station based on the position coordinates of the three identified base stations and the three curved paths of possible positions of the mobile station.

11. The method of claim 10 wherein calculating the curved path of possible positions of the mobile station for each of the three identified base stations is performed according to the relationship
$${RSSI}_{i} ∝ \frac{1}{{d}_{i}^{2}}$$
, wherein RSSIᵢ stands for a measured RSSI value for an i^{th} base station, and dᵢ stands for a distance between the mobile station and the i^{th} base station.

12. The method of claim 10 wherein when calculating the curved path of possible positions of the mobile station for each of the three identified base stations, a known interference coefficient for each base station is utilized to calculate an inner curve and an outer curve corresponding to that base station, the inner curve and the outer curve defining an individual area that the mobile station is predicted to be in.

13. The method of claim 12 wherein a merged area that the mobile station is predicted to be in is calculated based on a union of the individual areas from each of the three identified base stations, the merged area comprising positions in which all of the individual areas overlap.

14. The method of claim 12 wherein the known interference coefficients for each of the three identified base stations comprise a mean interference value and a corresponding standard deviation value that are used to calculate the inner curve and the outer curve corresponding to the same base station.

15. The method of claim 10 wherein the mobile station receiving the position coordinates of the three identified base stations is realized by the three identified base stations transmitting their respective position coordinates to the mobile station.

16. The method of claim 10 wherein the mobile station receiving the position coordinates of the three identified base stations is realized by the mobile station reading the positions coordinates of the three identified base stations from a lookup table.

17. The method of claim 10 wherein when the mobile station is less than a predetermined distance away from a nearby base station in the mobile phone network, the position of the mobile station is set to be equal to the position of the nearby base station.
